(19) United States
(12) Patent Application Publication
(10) Pub. No.: US 2018/0007881 A1
(43) Pub. Date: Jan. 11, 2018

(54) FISHING LURE STORAGE CONTAINER

(71) Applicant: Stephen Downey, San Ramon, CA (US)

(72) Inventor: Stephen Downey, San Ramon, CA (US)

(21) Appl. No.: 15/642,234

(22) Filed: Jul. 5, 2017

Related U.S. Application Data
(60) Provisional application No. 62/358,503, filed on Jul. 5, 2016.

(51) Int. Cl. A01K 97/06; B65D 43/16; B65D 25/10; B65D 43/22; B65D 25/04

(52) U.S. Cl. CPC A01K 97/06; B65D 43/22; B65D 25/04; B65D 25/10; B65D 43/163

(57) ABSTRACT

A lure box comprising a box bottom and box top. The box bottom and box top can substantially enclose an interior space, but leave an access opening through which at least a portion of the interior space can be accessed. A lure shelf having a plurality of notches for hooking fishing lures and/or hooks can be proximate to the access opening. The lure box can also have a plurality of posts that fishing line can be wrapped around and/or between, such that a fishing lure or hook and a connected fishing line can be pulled from the lure box through the access opening when desired.

### BACKGROUND

### Field of the Invention

The present disclosure relates to the field of fishing equipment, particularly a container for storing lures and/or hooks.

### Background

Containers such as tackle boxes are often used to store and transport fishing equipment, including fishing lures, fishing hooks, and fishing line. However, conventional containers boxes often require that fishing line to be stored on spools separately from lures or hooks. When a user wants to use a particular lure, the user must open the box, remove a spool, unspool a desired length of fishing line and attach it to the lure. This can be time consuming and/or inconvenient.

What is needed is a fishing lure storage container that can hold hooks and lures that are already attached to fishing line, such that they can be readily accessible and be pulled from the container as needed without having to open the container.

### BRIEF DESCRIPTION OF THE DRAWINGS

FIG. 1A. depicts an embodiment of a lure box in a closed position.

FIG. 1B depicts an embodiment of a lure box in an opened position.

FIG. 2 depicts an embodiment of a box bottom.

FIG. 3 depicts an embodiment of a box top.

FIG. 4 depicts an embodiment of a box bottom storing a plurality of fishing hooks and connected fishing line.

FIG. 5 depicts an alternative embodiment of the present device.

FIG. 6 depicts the embodiment of FIG. 5 in use.

### DETAILED DESCRIPTION

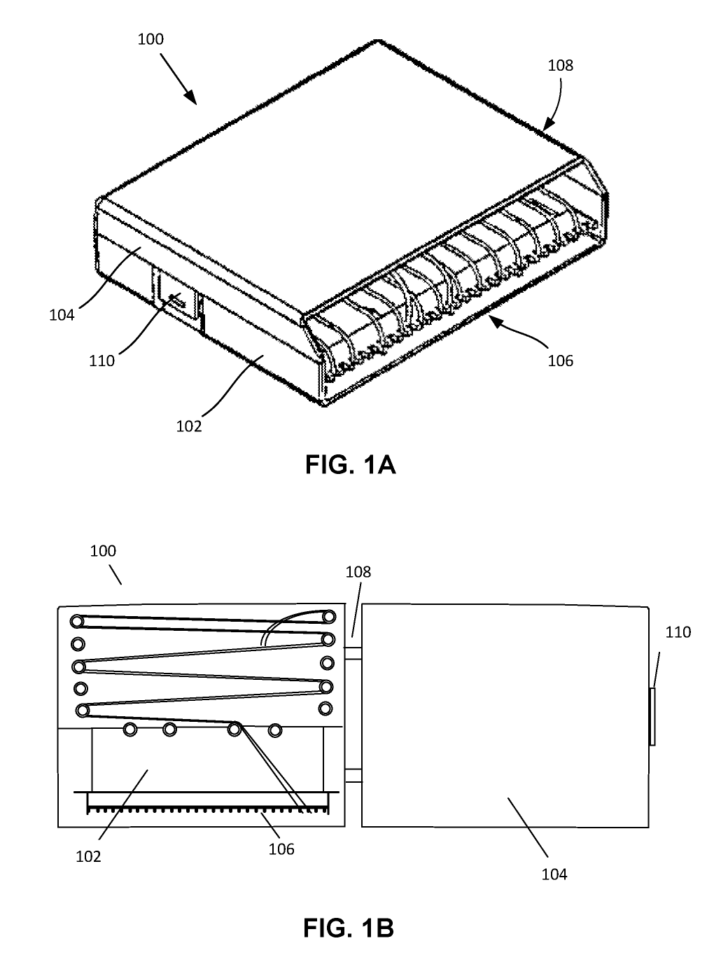

FIGS. 1A-1B depict an embodiment of a lure box 100. A lure box 100 can comprise a box bottom 102 and a box top 104 that can be selectively closed together to substantially enclose an interior space within a lure box 100. A lure box 100 can have at least one access opening 106 that allows a user to access at least a portion of the interior space when the a lure box 100 is closed. In some embodiments an access opening 106 can remain uncovered when the lure box 100 is closed, while in other embodiments a lure box 100 can further comprise a door, flap, sleeve, or any other known and/or convenient covering that can selectively close an access opening 106 while the rest of a lure box 100 remains closed.

A box bottom 102 and a box top 104 can be selectively moved between the closed configuration that substantially encloses the interior space as shown in FIG. 1A, and an open configuration that reveals the interior space as shown in FIG. 1B. In some embodiments, a box bottom 102 and a box top 104 can be removably coupled with one another via at least one hinge 108, such that a box bottom 102 and a box top 104 can be moved relative to one another about to open or close a lure box 100. A hinge 108 can be a pin, ball, or any other known and/or convenient device. In alternative embodiments a hinge 108 can comprise an integrated member along any portion of mating edges of a box bottom 102 and a box top 104. The box bottom 102 and/or box top 104 can comprise a closure component 110 that can selectively secure the lure box 100 in its closed configuration, such as a latch, clip, lock, or any other known and/or convenient device. A closure component 110 can be a separate member removably attached to or an integrated member with a box bottom 102 and/or box top 104. In alternate embodiments, a box top 104 can be entirely separated from a box bottom 102 when desired. By way of a non-limiting example, in some embodiments a box top 104 can be selectively coupled with a box bottom 102 using a press-fit connection, clips, latches, snaps, or any other known and/or convenient connection mechanism.

A box bottom 102 and a box top 104 can be comprised of a polymer, wood, metal, or any other known and/or convenient material. In embodiments comprised of a polymer, a box bottom 102 and a box top 104 can be fabricated as separate or integrated members via blowing, casting, extrusion, or any other known and/or convenient fabrication method.

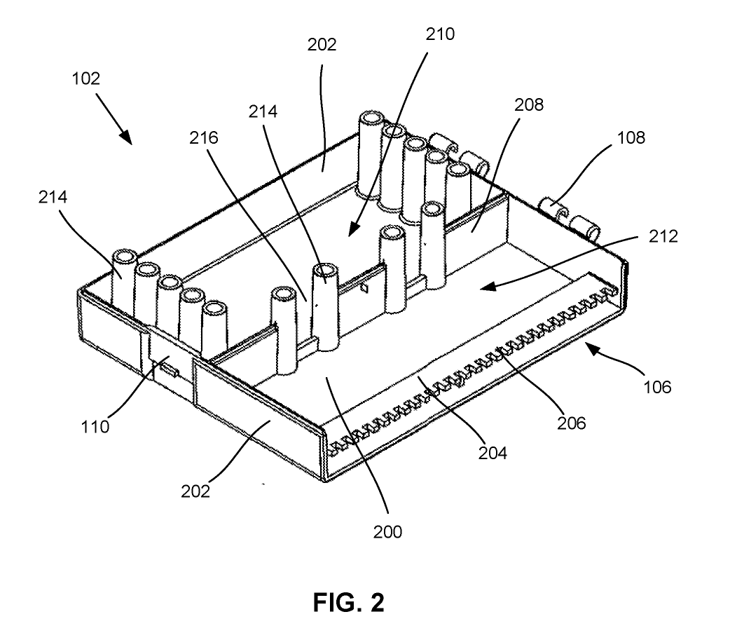

FIG. 2 depicts an exemplary embodiment of a box bottom 102. A box bottom 102 can comprise a bottom panel 200 and a plurality of bottom side walls 202. In some embodiments, a bottom panel 200 can be substantially rectangular, and bottom side walls 202 can extend from three side edges of a bottom panel 200, substantially orthogonally from the plane of a bottom panel 200. A bottom side wall 202 can be absent from at least a portion of one of the bottom panel's side edges, to leave an access opening 106 open on that edge.

In other embodiments, a bottom panel 200 can have rounded or any other known and/or convenient planar geometry. In such embodiments, bottom side walls 202 can extend substantially orthogonally from side edges of a bottom panel 200. A portion of a bottom side wall 202 can be absent to leave an access opening 106 along an edge of a bottom panel 200.

The box bottom 102 can comprise an elongated member 204 that can form a “lure shelf” extending across a box bottom 102 proximate to, and substantially parallel to, an access opening 106. An elongated member 204 can have a plurality of notches 206 along an edge proximal to an access opening 106. Notches 206 can be indentations into which a portion of a fishing hook or lure can be inserted to secure the fishing hook or lure. In some embodiments, notches can have dimensions to accommodate a portion of a hook or lure.

In some embodiments, an elongated member 204 can extend between two bottom side walls 202 at least partially away from the top surface of a bottom panel 200, such that a portion of a fishing hook or lure can extend from above the elongated member 204 through a notch 206, placing the terminal point of a hook or lure under an elongated member 204 between an elongated member 204 and a bottom panel 200. In other embodiments an elongated member 204 can be anchored on a bottom panel 200 but have an extension with notches 206 above a bottom panel 200 such that fishing lures or hooks can be hooked under the extension. In some embodiments a polymer member, such as, but not limited to a foam block, can be placed under the notched edge of an elongated member 204 to received pointed hook ends.

A box bottom 102 can have an interior wall 208 that can extend across a box bottom 102, substantially parallel to an access opening 106 and/or elongated member 204. In some embodiments, an interior wall 208 can be positioned substantially at the midpoints of substantially parallel side bottom side walls 202, but in other embodiments can be located at any other known and/or convenient point. In some embodiments, an interior wall 208 can extend between two bottom side walls 202 and can be substantially orthogonal to a box bottom 102 and bottom side walls 202.

An interior wall 208 can separate a box bottom's 102 interior space into a first compartment 210 and a second compartment 212. In some embodiments, a first compartment 210 can be surrounded by three bottom side walls 202 and an interior wall 208. A second compartment 212 can be defined by an interior wall 208 and two opposing bottom side walls 202, with an access opening 106 on its fourth side. An elongated member 204 can be positioned within a second compartment 212, proximal to an access opening 106.

A box bottom 102 can contain a plurality of posts 214. Each post 214 can be a column that can extend from a bottom panel 200, substantially orthogonally from the plane of a bottom panel 200. In some embodiments, posts 214 can be tubular with a substantially circular cross-section, but in other embodiments can be any other known and/or convenient geometry. In some of these embodiments, posts 214 can have a substantially uniform cross-section, but in other embodiments can also be tapered such that their diameter decreases as their distance away from a bottom panel 200 increases. Posts 214 can have a height that is approximately that of, greater than, or less than than the height of bottom side walls 202 and/or interior wall 208.

Interior wall 208 can have at least one pair of posts 214 positioned along its length, with a cutout 216 in an interior wall 208 positioned between each pair of posts 214. Each cutout 216 can be a gap in an interior wall 208, or a portion at which an interior wall's 208 height is decreased relative to other portions of the bottom middle wall 208. By way of a non-limiting example, in some embodiments an interior wall 208 can have four posts 214 and two cutouts 216 positioned along its length, with each cutout 216 located between a pair of posts 214 as shown in FIG. 2.

Additional posts 214 can also be positioned on a bottom panel 200 within a first compartment 210. In some embodiments two sets of posts 214 can be positioned within a first compartment 210, with posts 214 in each set being arranged substantially linearly such that one line of posts 214 can be proximate to one bottom side wall 202 and the other line of posts 214 can be proximate to an opposite bottom side wall 202, as shown in FIG. 2. In this exemplary arrangement, each line of posts 214 can be proximate to opposing ends of an interior wall 208. In other embodiments, posts 214 located in a first compartment 210 can be arranged substantially symmetrically, asymmetrically, in a curved path, or any other known and/or convenient geometry.

In some embodiments, a box bottom 102 can further comprise components of hinges 108 and/or closure components 110 that can selectively engage with corresponding components of a box top 104. By way of a non-limiting example, one bottom side wall 202 can have components of one or more hinges 108, while an opposing bottom side wall 202 can have components of a latch or other closure component 110, as shown in FIG. 2.

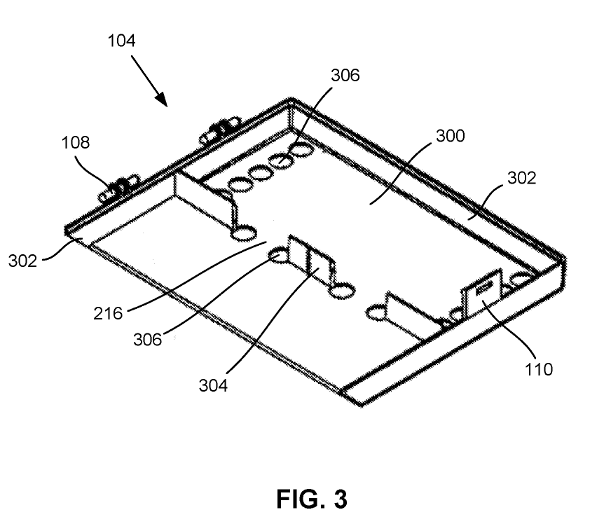

FIG. 3 depicts an exemplary embodiment of a box top 104. A box top 104 can comprise a top panel 300 and a plurality of top side walls 302. In some embodiments, a top panel 300 can be substantially rectangular, and top side walls 302 can extend from three side edges of the top panel 300, substantially orthogonally from the plane of the top panel 300. A top side wall 302 can be absent from at least a portion of one of a top panel's 300 side edges, to leave an access opening 106 open on that edge. In some embodiments, opposing top side walls 302 can terminate with an angled edge at the access opening 106, as shown in FIG. 3. Top side walls 302 can be sized and positioned such that exposed edges of top side walls 302 can contact exposed edges of bottom side walls 202 of a box bottom 102 when a lure box 100 is closed.

In some embodiments, a box top 104 can have a top interior wall 304 that extends between opposing top side walls 302. In some embodiments, an interior wall 208 can be positioned substantially at the midpoints of substantially parallel top side walls 302, but in other embodiments can be located at any other known and/or convenient point. A top interior wall 304 can be sized and positioned to contact a bottom interior wall 208 of a box bottom 102 when a lure box 100 is closed. In alternate embodiments, the top interior wall 304 can be absent, and a bottom interior wall 208 can have a height that reaches a top panel 300 when a lure box 100 is closed. The top interior wall 304 can also have cutouts 216 that can correspond to cutouts 216 in a bottom interior wall 208.

In some embodiments, a top panel 300 can comprise one or more post receptacles 306. Each post receptacle 306 can be an indentation, raised border, or any other known and/or convenient element that can selectively engage with a terminal end of a post 214 when a lure box 100 is closed. Each post receptacle 306 can correspond to a particular post 214 on a box bottom 102.

By way of a non-limiting example, a box top 104 can have a first set of post receptacles 306 configured to receive terminal ends of a first set of posts 214 arranged in a substantially linear geometry within a first compartment 210, a second set of post receptacles 306 configured to receive the tips of a second set of posts 214 arranged in a substantially linear geometry on an opposing end within a second compartment 212, and post receptacles 306 arranged along the top interior wall 304 that can be configured to receive the terminal ends of posts 214 positioned along the bottom middle wall 208, as shown in FIG. 3. Also as shown in FIG. 3, a pair of post receptacles 306 can be positioned at opposing ends of each cutout 216 in a top interior wall 304, to receive a corresponding pair of posts 214 positioned at ends of cutouts 216 in a top interior wall 304.

In alternate embodiments, post receptacles 306 can be absent, and the posts 214 can have a height that extends substantially to a top panel 300 when a lure box 100 is closed.

In some embodiments, a box top 104 can further comprise components of hinges 108 and/or closure components 110 that can selectively engage with corresponding components of a box bottom 102. By way of a non-limiting example, one top side wall 302 can have components of one or more hinges 108, while an opposing top side wall 302 can have components of a latch or other closure component 110, as shown in FIG. 3.

In some embodiments, a box bottom 102, a box top 104, and/or any or all of their individual components can be formed as molded plastic. In other embodiments, any or all components of a lure box 100 can comprise metal, metal alloy, polymers, wood, or any other desired material.

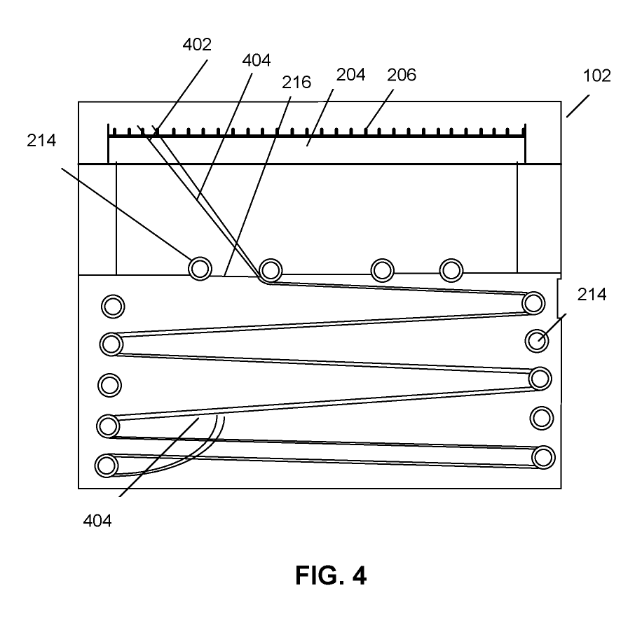

FIG. 4 depicts an embodiment of a box bottom 102 in use with fishing hooks 402 and fishing lines 404 coupled with the fishing hooks 402. In use, a fishing hook 402 or a fishing lure can be hooked through a notch 206 in an elongated member 204. When a lure box 100 is open, fishing line 404 connected to a lure or hook 402 can be passed through a cutout 216 in the bottom interior wall 208, between a pair of posts 214 in a bottom interior wall 208 as shown in FIG. 4. The fishing line 404 can be further wrapped around and/or between one or more of posts 214 within a first compartment 210. By way of a non-limiting example, the fishing line 404 can be crisscrossed back and forth between posts 214 on alternate sides of a first compartment 210, as shown in FIG. 4.

As shown in FIG. 4, multiple fishing lures and/or hooks 402 can be stored within a lure box 100 in this manner, along with their attached fishing lines 404. A lure box 100 can be closed to store or transport the fishing lures and/or hooks 402 and fishing line 404.

When a user desires to use a particular fishing lure or hook 402, the user can access the lure or hook 402 through the access opening 106 when a lure box 100 is closed, as shown in FIG. 1A. The user can pull the lure or hook 402 away from the lure shelf 204 and out of an access opening 106, such that the connected fishing line 404 is also pulled out of the lure box via an access opening 106. The connected fishing line 404 can be held between the posts 214 with enough tension to maintain it and the attached hook 402 or lure during storage and transportation, but the user can apply enough force to pull the fishing line 404 between the posts and out of a lure box 100 when desired.

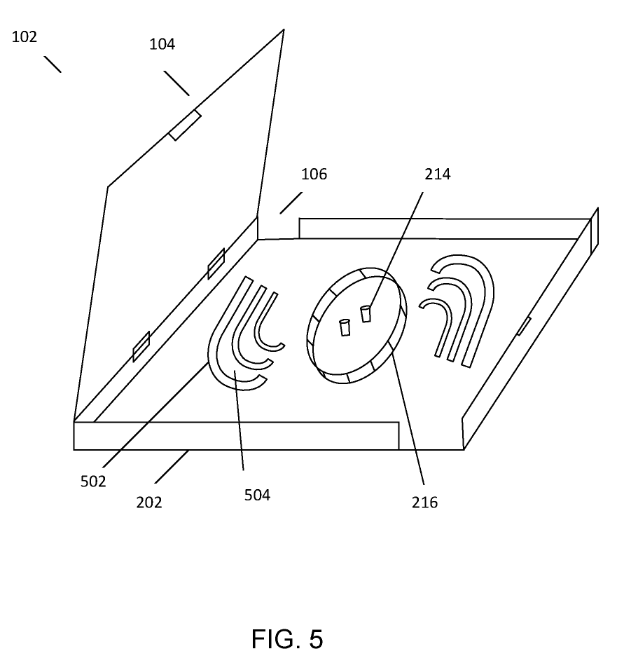

As shown in FIG. 5, an alternative embodiment of the present device can have a box bottom 102 with a bottom interior wall 208 forming a substantially circular geometry than can define a first compartment 210, surrounded by a second compartment 212. In other embodiments, a bottom interior wall 208 can be configured to form any known and/or convenient closed or open geometry. A bottom interior wall 208 can have a plurality of cutouts 216 spaced substantially regularly along its length. In some embodiments, cutouts 216 can be slits, but in other embodiments can be substantially rectangular, angled, rounded, or any other known and/or convenient geometry.

In the embodiment shown in FIG. 5, a plurality of ridges 502 can be within a second compartment, outside of a bottom interior wall 208. Ridges 502 can have a proximal end proximal to a bottom interior wall 208 and a distal end proximal to a bottom side wall 202. As shown in FIG. 5, ridges 502 can have a semi-curved geometry, but in other embodiments can be linear or any other known and/or convenient geometry. Ridges 502 can be arranged in at least one set and placed substantially parallel to each other to form laterally adjacent channels 504 on a bottom panel 200. As shown in FIG. 5, some embodiments can have two sets of ridges 502 located on substantially opposite sides of a second compartment 212.

In the embodiment shown in FIG. 5, a bottom side wall 202 can have at least one access opening 106, which can substantially align with the distal ends of a set of ridges 502. As shown in FIG. 5, an access opening 106 can have a serrated bottom edge 506. A box top 104, as shown in the embodiment in FIG. 5 can also comprise a top panel 300 that can lie adjacent to the open edges of bottom side walls 202 when the box is closed.

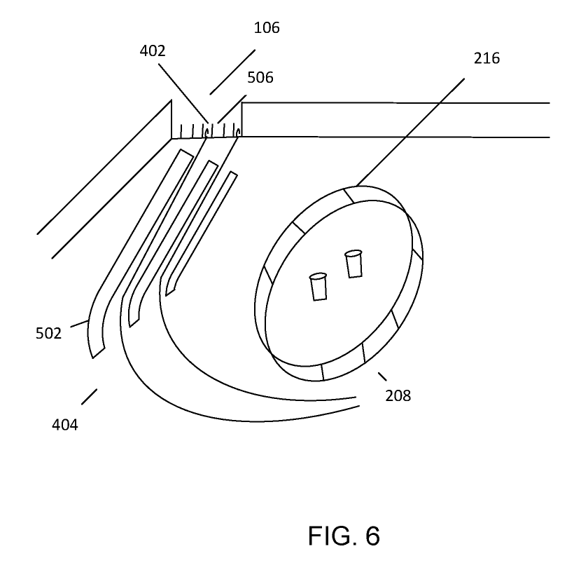

The embodiment of FIG. 5 can be used with fishing hooks 402 and fishing lines 404 coupled with the fishing hooks 402, as shown in FIG.6. In this embodiment a fishing hook 402 or a fishing lure can be hooked to a serrated edge 506. When a lure box 100 is open, fishing line 404 connected to a lure or hook 402 can follow a path of a channel 504 and wrap around an interior wall 208.

Multiple fishing lures and/or hooks 402 can be stored within a lure box 100 in this manner, along with their attached fishing lines 404. A lure box 100 can be closed to store or transport the fishing lures and/or hooks 402 and fishing line 404.

When a user desires to use a particular fishing lure or hook 402, the user can access the lure or hook 402 through an access opening 106 when a lure box 100 is closed. The user can pull the lure or hook 402 away from a serrated edge 506 and out of an access opening 106, such that the connected fishing line 404 is also pulled out of the lure box via an access opening 106. The connected fishing line 404 can be held around an interior wall 208 with enough tension to maintain it and the attached hook 402 or lure during storage and transportation, but the user can apply enough force to pull the fishing line 404 out of a lure box 100 when desired.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A fishing lure box, comprising:
a box bottom having a substantially rectangular bottom panel and a plurality of side walls extending substantially orthogonally from said bottom panel, and at least one opening in one of said side walls;
a bottom interior wall defining a first compartment and a second compartment on said box bottom and having at least one opening along its length,
wherein the second compartment contains an elongated member having an interior and an exterior edge that extends between opposite side walls substantially parallel to the bottom panel and proximal to said opening, wherein said exterior edge has a plurality of notches;
wherein the first compartment contains a plurality of posts extending substantially orthogonally and upward from the bottom panel;
a box top having a substantially rectangular top panel and a plurality of side walls extending substantially orthogonally from the edges of said top panel;
wherein said box top and box bottom are removably connected via a hinge device along one side and a latching device on the opposite side of the box.

2. The fishing lure box of claim 1, wherein said box top further comprises indented regions having substantially the same planar cross-sectional area and geometry of the posts and substantially aligning with said posts when the box is closed.

3. A fishing lure box, comprising:
a box bottom having a substantially bottom panel and at least one side wall extending substantially orthogonally from the edges of said bottom panel, and at least one opening in said at least one side wall;
a bottom interior wall having an inner surface and an outer surface that is configured into a substantially closed-curve geometry and having at least one opening along its length;
wherein said bottom interior wall defines a first compartment adjacent to the interior surface of said interior wall and a second compartment adjacent to the exterior surface of the wall on said box bottom;
wherein the second compartment contains a plurality of ridges extending upward from the bottom panel and having a proximal end proximal to the bottom interior wall and a distal end proximal to a side wall and substantially aligned with an opening in a side wall;
wherein said ridges have a substantially curved geometry;
wherein the first compartment contains a plurality of posts extending substantially orthogonally and upward from the bottom panel;
a box top having a top panel having substantially the same planar cross-sectional area and geometry of the box bottom and at least one side wall extending substantially orthogonally from said top panel;
wherein said box top and box bottom are removably connected via at least one hinge device located on one side of the box and a latching device on the opposite side of the box.
